(19) United States
(12) Patent Application Publication
(10) Pub. No.: US 2015/0017385 A1
(43) Pub. Date: Jan. 15, 2015

(54) PASSIVE DRAG MODIFICATION SYSTEM

(71) Applicant: THE BOARD OF TRUSTEES OF THE UNIVERSITY OF ALABAMA, Tuscaloosa, AL (US)

(72) Inventor: Amy Warncke Lang, Tuscaloosa, AL (US)

(21) Appl. No.: 14/383,639

(22) PCT Filed: Mar. 8, 2013
(86) PCT No.: PCT/US13/29908

§ 371 Date: Sep. 8, 2014

Related U.S. Application Data
(60) Provisional application No. 61/608,453, filed on Mar. 8, 2012.

(51) Int. Cl. B32B 7/00; F15D 1/00; B32B 33/00

(52) U.S. Cl. CPC B32B 7/00; B32B 33/00; F15D 1/003
USPC 428/141

(57) ABSTRACT

The present invention is directed to a micro-array surface that provides for drag reduction. An aerodynamic or hydrodynamic wall surface that is configured to modify a fluid boundary layer on the surface is provided. The wall surface has a plurality of cavities defined therein the surface. In various examples, the interaction of the cavities with a flow of fluid relative to the wall surface is configured to form a plurality of stable, embedded cavity vortices such that a partial slip condition is produced over the wall surface.

### CROSS REFERENCE TO RELATED APPLICATIONS

This application claims the benefit of and priority to U.S. Provisional Patent Application No. 61/608,453, filed Mar. 8, 2012, which is hereby incorporated by reference in full and made a part hereof.

### FIELD OF THE INVENTION

An improved apparatus for reducing or enhancing the skin friction drag of an aerodynamic or hydrodynamic surface, and in particular to an improved micro-array surface design for reducing or enhancing the skin friction drag coefficient and/or heat transfer rate of aerodynamic or hydrodynamic surfaces.

### BACKGROUND

It has previously been assumed that the scales covering butterfly wings provide an aerodynamic advantage, but how the scales function and allow flight through the air with less effort was unknown. Butterflies (family Lepidoptera meaning scaled wings) have been studied for the unique aspects of their scales, especially in terms of their bio-inspired optical properties. In 1967, Nachtigal attempted to determine the lift and drag on dead specimens under gliding conditions in a wind tunnel experiment. His results indicated increased lift with the presence of the scales. Later research in the early 1990's began to look at low Reynolds number experiments and simulations to study the vortex formation within a triangular cavity modeled after the shingle-like pattern observed on butterfly scales. This research documented vortex formation at various Reynolds numbers but failed to adequately resolve any aerodynamic function of the scales. There is also a large body of work that has studied butterflies and/or moths in flight as well as leading edge vortex formation in general for insect flight, but none of these studies considered the aerodynamic effect of butterfly scales.

### SUMMARY

Embodiments of this invention provide a surface of an object that is configured to provide for either drag reduction or enhancement, with the latter being beneficial in applications where increased turbulent mixing is desired such as in heat transfer applications. In one aspect, an aerodynamic or hydrodynamic wall surface that is configured to modify a fluid boundary layer on the surface comprises at least one array of roughness elements disposed on and extending therefrom the surface. In one example, the interaction of the roughness elements with a boundary layer of fluid can act to reduce the skin friction drag coefficient of the surface over an identical smooth surface without the roughness elements.

In a second embodiment, a method for a reduction in skin friction drag comprises a plurality of three-dimensional cavities. In one aspect, an array of stable, embedded cavity vortices within a micro-roughness surface geometry can be formed that produces a three-dimensionally patterned partial slip condition over the surface. This complex boundary condition passively forces the boundary layer flow and results in sub-laminar skin friction. In another aspect, the formed boundary condition can act to delay transition to turbulence within the boundary layer. Features of the transition process from a laminar to a turbulent boundary layer can occur in small scale flow structures close to the wall. These structures can be altered by the presence of the partial-slip boundary condition due the presence of the micro-cavities.

In one embodiment, a method for a reduction in skin friction drag comprises a plurality of three-dimensional cavities. In one aspect, a plurality of stable, embedded cavity vortices within a micro-roughness surface geometry can be formed that produce a three-dimensionally patterned partial slip condition over the surface. In another aspect, upon movement of the surface at a predetermined velocity relative to a surrounding fluid, at least one embedded cavity vortex can bulge up and at least partially out of the cavity. This vortex can act as a rollerbearing to alleviate the no-slip condition.

Other systems, methods, features, and advantages of the drag modification system of the present application will be or become apparent to one with skill in the art upon examination of the following figures and detailed description. It is intended that all such additional systems, methods, features, and advantages be included within this description, be within the scope of the passive micro-array system, and be protected by the accompanying claims.

### BRIEF DESCRIPTION OF THE DRAWINGS

The accompanying drawings, which are incorporated in and constitute a part of this specification, illustrate certain aspects of the instant invention and together with the description, serve to explain, without limitation, the principles of the invention. Like reference characters used therein indicate like parts throughout the several drawings.

FIG. 1 shows a schematic flow model for a drag enhancing d-type surface roughness, in which downwash is shown between the counter-rotating vertex pair and upwash, that would occur on either side, is shown on the front region of the surface roughness.

FIG. 2 shows a schematic flow model for a drag reducing d-type surface roughness, in which outflow, as depicted by the arrows, from the upstream cavity to the adjacent neighboring downstream cavity occurs through the valleys in the saw tooth geometry of the formed ridges.

FIG. 3 shows a schematic front elevational view of one embodiment of a ridge of an array of roughness elements. In one aspect, for drag reduction, the elements can be aligned such that the peaks of the roughness elements of each adjacent ridge can be staggered and can be spaced at about half the peak height of the roughness element. In this view, flow will encounter the ridge by moving into the figure. In one exemplary aspect, the spacing between the peaks of the adjoined roughness elements is on the order of about 30 viscous length scales at close to maximum velocity for the fluid passing over the wall surface.

FIG. 4 is a side elevational schematic view of the exemplary micro-array of roughness elements shown in FIG. 3, showing the tops of the roughness elements of FIG. 3 and showing the formation of counter-rotating streamwise vortices due to the staggered alignment of adjacent rows of the roughness elements in the drag enhancing case. The flow of fluid is directed into the figure.

FIG. 5 is a top elevational schematic view of exemplary vertex structures that form within the transversely extending cavities of an exemplary micro-array of roughness elements of FIG. 3, showing fluid flow moving from the bottom to the top of the figure and showing dark short lines correspond to the peaks of the roughness element in FIG. 3.

FIG. 6 is a perspective view of one embodiment of a roughness element of a micro-array of the present application, showing riblets formed on a front, upstream surface of the roughness element.

FIG. 7 is a side elevational view of the roughness element of FIG. 6.

FIG. 8 is a top elevational view of the roughness element of FIG. 6.

FIG. 9 is front, upstream elevational view of a plurality of adjoined roughness elements of FIG. 6 that form a ridge, and showing a plurality of channels formed between portions of the respective bases and the bottom portions of the peripheral edges of the respective adjoined roughness elements.

FIG. 10 is a perspective view of a portion of a micro-array, showing a plurality of staggered rows of the formed ridges of adjoined roughness element of FIG. 8, and showing the approximate spacing between the rows of ridges to be approximately half the height of a roughness element.

FIG. 11 is a schematic diagram of cavity flow of representative fluid flow between the tops of roughness elements of FIG. 6 and across one “valley,” the roughness elements being positioned in adjacent ridges or rows. In this diagram, fluid flow over the surface is from left to right.

FIG. 12 is a top elevational schematic view of exemplary vertex structures that form on an exemplary micro-array of roughness elements of FIG. 6, showing fluid flow moving from the left to the right of the figure. The orange vortices represent the outer vortices shown in FIG. 11 and can have small counter-rotating vortices superimposed on the outer-vortices that make the flow field consistent to its neighboring vortices. In the exemplified aspect with three riblets on the front face of the roughness element, two counter-rotating vortices would form with an upwelling between them and a downwash to the flow at the sides. These vortices are also known as Taylor-Gortler vortices. The blue vortex tubes represent the vortex cores to the vortex array that link all the individual outer cavity vortices together.

FIG. 13 is a graphical illustration of a two-dimensional computational fluid dynamics (CFD) numerical calculation through a line of symmetry over the peaks and valleys of the roughness elements in drag reduction mode. The cavity Re for this calculation is 2000, and the formation of stable cavity vortices is observed.

FIG. 14 is a graphical illustration of the velocity profiles in the boundary layer forming over the surface in FIG. 13 above the third and eighth cavities. These profiles are compared to that of a flat plate boundary layer, known as the Blasius solution. One can observe the non-zero velocity over the surface of the cavities due to the embedded cavity vortex. One skilled in the art will appreciate that one can obtain the momentum thickness of the two boundary layers, which is proportional to the total drag coefficient on the plate from the leading edge to that corresponding downstream distance, by integrating these velocity profiles. In one example, the momentum thickness over the third cavity is 16.09% of the momentum thickness of the flat plate Blasius solution, while at the eighth cavity the percentage of the momentum thickness of the surface with cavities with respect to the flat plate solution is 23.91%. Thus, at the third and eighth cavity, the drag coefficient is reduced by 84% and 76% correspondingly.

FIG. 15 illustrates isocontours of streamwise velocity in a laminar flow just over one open cavity in a periodic array. Upstream of the cavity the flow is uniform. Over the cavity, the flow speeds up as there is little viscous drag. The speed-up in fact begins about one cavity width, h, upstream and extends laterally by a fraction of h. The isocontours of streamwise velocity are at a height of 0.1 h above cavity surface in a laminar flow and the slot width Re=4 is based on the peak streamwise velocity in the slot exit plane.

FIG. 16 shows a perspective view of an exemplary honeycomb patterned micro-cavity surface.

FIG. 17 shows a partial cross-sectional view of the honeycomb patterned micro-cavity surface of FIG. 16 taken across line 17-17. This example showing the wall of the cavities configured with a parabolic profile such that the edges of the cavities are minimal in size.

FIG. 18 shows an offset, cubic micro-cavity pattern showing the partial slip pattern (in grey with a green arrow) boundary condition created by the induced flow of the embedded vortices. This illustrates the corresponding partial slip field to which the outer flow is subjected to an exemplary three-dimensional array of micro-cavities embedded in the wall surface (the three-dimensional array of micro-cavities being shown exemplarily as an offset, square patterned micro-cavity field). The complex partial slip condition pattern can be designed, via the geometry and sizing of the cavities, to disrupt the formation of high and low speed streaks in the near wall layer that lead to the transition to turbulence in the boundary layer.

FIG. 19 shows a typical convergence pattern of skin-friction lines leading towards a three-dimensional separation line. When three-dimensionality is added to the separation flow kinematics, boundary layer separation does not always coincide with a point of zero shear stress at the wall. In fact, the shear stress can vanish only at a limited number of points along the separation line, and a convergence of skin-friction lines onto a particular separation line is required for separation to occur.

FIG. 20 shows the theorized cavity vortices which should form between adjacent roughness elements for angled configurations. In this example of a passive micro-roughness array with preferential flow direction, transverse triangular roughness elements extend into the flow at an angle between 0 and 90 degrees. The figure illustrates an exemplary array of roughness elements in which the crown of each respective roughness element is positioned at an angle of about 40 degrees with respect to the flow. Preferred flow direction is from left to right in the figure and the red lines represent embedded vortices that would form between adjacent roughness elements.

FIGS. 21A-B show an exemplified micro-array of roughness elements built for water testing.

FIG. 21C shows fluorescent dye visualization of embedded vortices forming in the exemplary roughness surface shown in FIGS. 21A and 21B.

FIGS. 22A-22C show velocity vectors of flow over the model shown in FIG. 21A. FIG. 22A shows the laminar boundary conditions; FIG. 22B shows the top view of the laminar boundary layer; and FIG. 22C shows a side view of the turbulent boundary layer.

FIG. 23 is a side elevational schematic view of an array of roughness elements, according to another embodiment, showing the roughness elements positioned at an acute angle relative to the underlying surface.

FIG. 24 is a side elevational schematic view of a plurality of roughness elements, according to one aspect, showing the roughness elements positioned at an acute angle relative to the underlying surface and an embedded vortex formed within a cavity.

FIG. 25 is a graphical representation of Couette flow variation of a moving top plate versus bottom cavity plate for Re=5 showing the shape of the embedded vortex changing at different fluid and cavity speeds. As the ratio of the speed of the top plate (Uₜₒₚ) relative to the speed of the cavity (U_{cav}) decreases, the ratio of the coefficient of drag for the cavity (U_{d, cav}) to the coefficient of drag for a flat plate (U_{d, fp}) also decreases.

FIGS. 26a-26d are photographs of the scales of a Monarch butterfly.

FIG. 26e is a photograph of a cross-section of the wing of a Monarch butterfly with a plurality of roughness elements superimposed over the scales on the wing.

FIG. 27 is a graphical illustration showing the change in drag at various Reynolds numbers for flow transverse and parallel to the cavities.

FIGS. 28a-28c are graphical illustrations showing computational results illustrating the shape of the embedded vortex changing for varying Reynolds numbers.

FIG. 29 is a graphical illustration showing the change in drag coefficient reduction as a function of Reynolds number.

FIG. 30 is a graphical illustration showing the percent change in drag coefficient reduction as a function of Reynolds number.

FIG. 31 is a schematic view of a butterfly showing scale placement and fluid flow around a portion of the wings of the butterfly.

### DETAILED DESCRIPTION OF THE INVENTION

The present invention can be understood more readily by reference to the following detailed description, examples, drawings, and claims, and their previous and following description. However, before the present devices, systems, and/or methods are disclosed and described, it is to be understood that this invention is not limited to the specific devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used in the specification and the appended claims, the singular forms “a,” “an” and “the” include plural referents unless the context clearly dictates otherwise. Thus, for example, reference to “a roughness element” includes arrays of two or more such roughness elements, and the like.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

As used herein, the terms “optional” or “optionally” mean that the subsequently described event or circumstance may or may not occur, and that the description includes instances where said event or circumstance occurs and instances where it does not.

The present invention can be understood more readily by reference to the following detailed description of embodiments of the invention and the Examples included therein and to the Figures and their previous and following description.

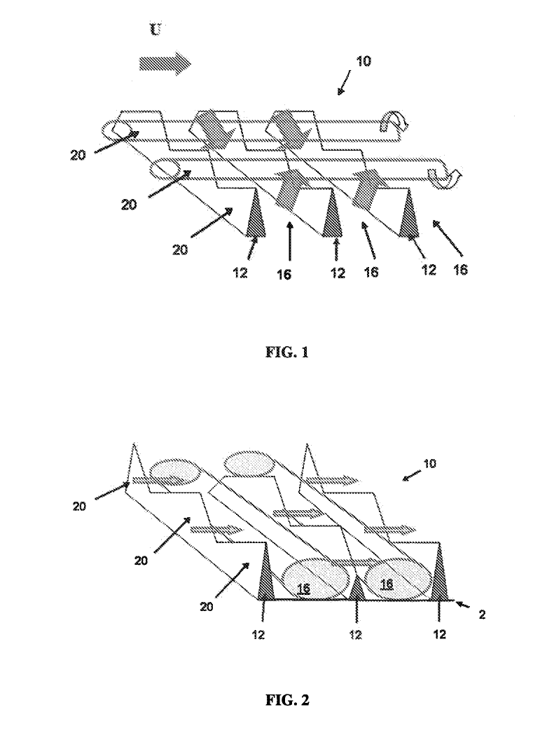

Referring to FIG. 1, an array 10 of roughness elements with the induced flow field is illustrated. As shown, spanwise or transverse cavities 16 defined between the ridges 12 that are exemplarily formed from adjoined roughness elements 20 that are positioned substantially transverse to the flow of the fluid over the surface 2, which results in a series of cavity flows, each containing a re-circulating flow field. In the exemplary embodiment illustrated in FIGS. 1 and 2, roughness elements 20 are integrally connected together to form individual ridges 12 that are positioned on and extend from the surface 2 substantially transverse to the flow of fluid across the surface 2. In one aspect, the ridges 12 are spaced substantially uniform and, optionally can be variably spaced.

In one aspect, due to the spacing of the saw tooth peaked roughness elements 20, an on average streamwise vortex forms in the flow above each cavity, such as found in the case of drag enhancing riblets. In one aspect, it is contemplated that the cavities would comprise vortices of alternating sign as this would appear to provide the most stable flow regime. In this aspect, and as illustrated, neighboring vortices contribute to upwashes and downwashes in an alternating manner across the spanwise direction.

One skilled in the art will also appreciate that alternative shapes of the roughness elements 20 are contemplated. Exemplary alternative shapes can comprise, but are not meant to be limited to, a blade-like thin peak, which allows the formation of an increased number of vortices in a predetermined spanwise dimension, a trapezoidal cross-sectional shape with a flat portion of the ridge over which the vortices will form, and the like.

Independent of the ideal shape of the ridges 12, the overall characteristics of the flow field remains unchanged. In operation, and referring to FIG. 1, a fluid particle would enter from the left at some distance above the surface 2, such as exemplary shown as a flat plate. As the fluid particle approaches the surface it feels the presence more of the counter-rotating vortex pair and is pulled downward into a region of downwash. As it enters this downwash, the fluid particle enters the cavity 16 and is spun around, in an almost slingshot type motion, and injected back out above the surface through an upwash region of the channels. From a heat transfer standpoint, the proposed surface causes fluid particles far away from the surface to come in contact (or very near) to the surface for a short period of time and then to be pushed out again far above the surface. With this “on average” flow field, the burst/sweep process has been accentuated and controlled to take place in an organized manner. Thus, in one aspect, the exemplary array 10 of roughness elements 20 provides an efficient manner by which a turbulent boundary layer flow can be optimized for convective heating/cooling purposes over a solid surface.

In one exemplary aspect, in order to cause as much fluid as possible to come in contact with the “rough” surface 2, the spacing between the transverse cavities 16 should be minimized. However, if the spacing became too small, the mass flow rate pumped through the cavities would decrease due to viscous effects. In one exemplary aspect, the average height of the ridges (h⁺) is substantially equal to the width of the cavity (w⁺), or is about a one to one height to width ratio (h⁺≈w⁺). In another aspect, with respect to the average height of the cavities, it can be greater than about half the peak-to-peak amplitude of the saw tooth pattern along the ridges. In an exemplary aspect, the amplitude for riblet spacing would be about and between 10 s⁺ to 20 s⁺. In another example, the amplitude would be about 15 s⁺. In this aspect, this would also be the average height of the ridges, with the minimum valley point of the ridges located at an elevation of s⁺ that is about 7.5 (±2.5) above the bottom of the cavity, and maximum peak located at s⁺ that is about 22.5 (±2.5).

In a further aspect, the wavelength of the saw tooth pattern can be about λ⁺=40, based on the size of a typical vortex mentioned previously of s⁺ being about 30. This would be sufficient to hold a vortex between the peaks. Of course, it will be appreciated that these dimensions are exemplary only and are not meant to be limiting. Further, one will appreciate that the exemplary dimensions can be scaled as desired.

Referring now to FIG. 2, an exemplary flow field through the drag reducing roughness element 20 is illustrated. It has been demonstrated that a series of transverse cavities 16 with substantially constant ridge height is prone to a random efflux/influx of fluid due to the high shear region located above the cavities. This high shear region results in the formation of streamwise vortices and low speed streaks above the cavities such as found in the smooth surface case. It is likely that the peak velocity can be larger for cavities 16 formed by a series of transverse blades, but would more than likely still be a large enough percentage below the freestream that streamwise vortices would still be formed due to a high shear region above the cavities. As shown in FIG. 2, to prevent and/or reduce the efflux/influx process out/into the cavities, a saw tooth geometry is defined by the respective roughness elements 20 that form the ridges 12 of the array of roughness elements.

In this example, the substantially transverse cavities formed between the adjacent ridges help with the stability of the flow field as the flow through the cavities is given a longer distance (two cavity widths as opposed to one) by which it is exposed and pulled along by the flow directly above. As a result of the exemplary geometry, the estimated peak velocity achieved is in a range between about 5 to 40 percent of the freestream flow. Second, the jets formed through the cavities are substantially tangent to the flow above so that very little vertical velocity component is formed. If one were looking down onto the surface, the formed jets would appear to be a periodic array of suction and blowing at a smooth wall. Finally, the flow acting on the bottom of the cavities results in a shear stress that provides thrust to the surface. In this case the effect is such that it can act to cancel out a large percentage of the skin friction losses due to the momentum change in the flow over the vertical walls of the cavities. It is contemplated that this effect is more pronounced as higher peak velocities in the jets (and thus closer to the bottom surface of the cavities) are achieved. Thus, in one example, the width of the cavities 16 can be increased or maximized (such that the stable flow field in FIG. 2 is maintained) so as to decrease the number of spanwise channels over a given surface area.

In this aspect, considering an averaged streamline through the roughness element 20, a fluid particle that starts from the left close to the surface would approach a transverse cavity in the array and upon entering the cavity be captured by the cavity vortex and travel around in a spiral motion before being passed through another cavity just to enter the neighboring cavity and repeat the previous motion. In this example, all fluid near the ridge stays near the ridge and there is little or no on average vertical velocity component away from the cavities of the array. Given the flow model as stated, and that the cavities are dimensionally small enough such that viscous effects dominate, it is contemplated that the net skin friction drag over such an exemplary surface could start to approach that of a laminar flat plate boundary layer.

In one aspect, the formed “rough” surface can be categorized as a series of trapezoidal channels (d-type roughness geometry) that are orientated in the spanwise direction (transverse to the flow of fluid across the array), but, in one exemplary aspect, with a saw tooth geometry of alternating peaks along the ridges of the channels giving the surface a three-dimensional, yet repeatable, pattern. The alignment of the peaks in the streamwise direction of the flow of fluid is proposed to increase drag, while the alternation of the peaks in the streamwise direction will decrease drag. In one aspect, the spacing between the ridges 12 in the streamwise direction can vary from ½ to a full value of the peak height (or amplitude) of the ridges with respect to the bottom of the cavities. In another aspect, the distance between adjacent successive ridges can be in a range of between about 40 to 60% of the peak longitudinal height or amplitude of the roughness elements that form the respective ridges. Optionally, the distance between adjacent successive ridges can be in a range of between about 45 to 55% of the peak longitudinal height or amplitude of the roughness elements that form the respective ridges

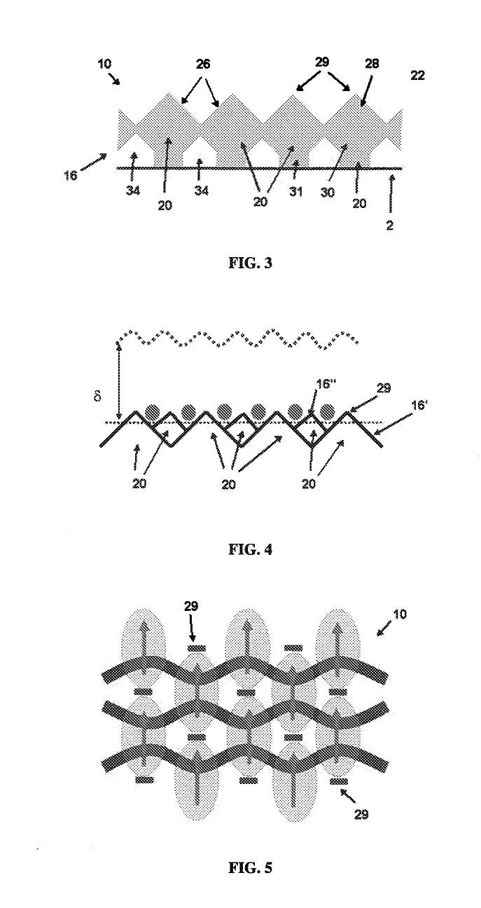

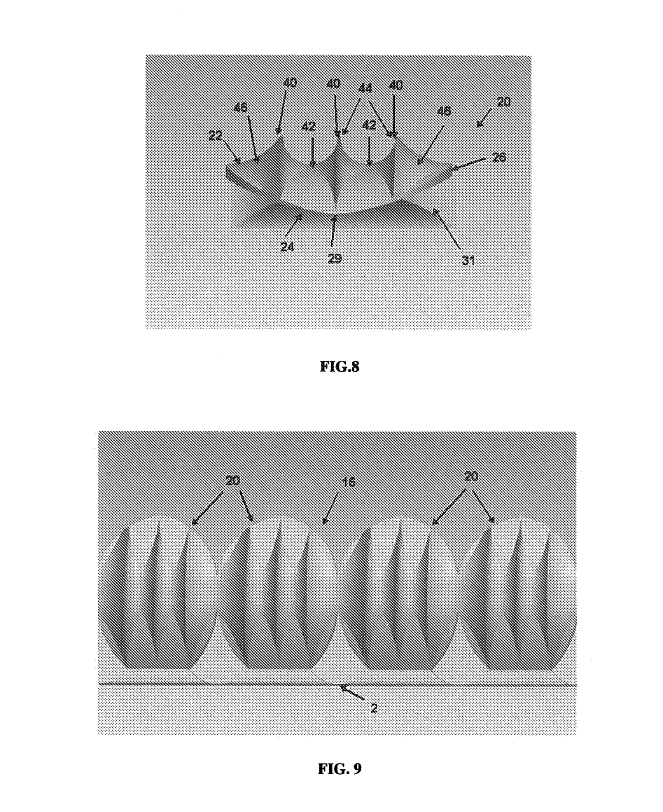

In an alternative embodiment, and referring now to FIGS. 3-12, the micro-array 10 can comprise a plurality of roughness elements 20 that can extend from the surface and be positioned in spaced ridges along the surface 2. In this aspect, it is contemplated that each roughness element 20 has a front, upstream surface 22 and an opposing rear, downstream surface 24. Further, each roughness element has a peripheral edge 26 that has an upper portion 28 that tapers to a top 29 and a bottom portion 30 that tapers to a base 31. As one would appreciate, the base is configured to be connected to the underlying surface 2 of the object. In one exemplified aspect, the roughness elements 20 are positioned on the underlying surface 2 substantially transverse to the flow of the fluid across the surface. In another aspect, the roughness elements extend substantially normal to the underlying surface. For example, and not meant to be limiting, the transverse longitudinal height of the roughness elements can be between about 0.001 to 2.00 cm.

In one aspect, a plurality of roughness elements 20 can be positioned transverse to the flow of fluid across the surface such that a distance between a medial portion 32 of the peripheral edges of adjacent and aligned roughness elements 20 is less than the distance between the respective tops 29 of the roughness elements and is less than the distance between the respective bases 31 of the roughness elements. In a further aspect, adjacent and aligned roughness elements 20 can be connected at some selected portion of the respective peripheral edges of the roughness elements. In this aspect, a channel 34 is defined therebetween portions of the bases and the bottom portions 30 of the peripheral edges 26 of the adjacent and adjoined roughness elements. In one exemplary aspect, it is contemplated that the formed channels would extend longitudinally substantially co-axial to the flow of the fluid across the surface. In an alternative aspect, the adjoining roughness elements can be connected together such that no channel is formed therebetween the respective adjoining elements. In a further aspect, the adjoined roughness elements can form a “saw tooth” ridge that extends substantially transverse to the fluid flow.

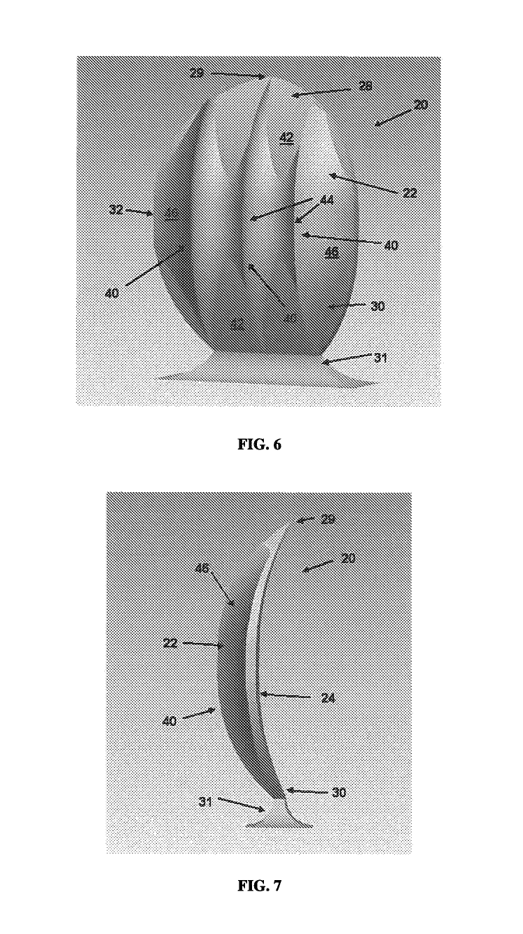

In one embodiment, the roughness element 20 has a substantially diamond cross-sectional shape, as shown in FIG. 3. Alternatively, and as shown in FIG. 6, the roughness element 20 can have a substantially oval shape. Of course, one skilled in the art will appreciate that other geometric shapes are contemplated and that the aspects illustrated are merely exemplary.

Referring now to FIGS. 6-10, in one aspect, it is contemplated that the front, upstream surface 22 of the roughness element 20 has a curved, convex cross-sectional shape relative to the flow of fluid across the surface 2 of the object. In another aspect, it is contemplated that the rear, downstream surface 24 of the roughness element has a curved, concave cross-sectional shape relative to the flow of fluid to promote the recirculation of the flow within the cavity, and to act as a streamlining effect in both stabilizing and promoting the embedded vortex flow field. In one aspect, this slight concavity in the rear surface 24 of the roughness element also acts to position the tops 29 of the roughness elements at a slight, acute angle relative to the underlying surface such that the tops of the roughness elements do not protrude into the fluid flow normal to the flow direction. In one aspect, it is contemplated that the radius of curvature of the rear surface 24 of the roughness element is less than the radius of curvature of the front surface 22 of the roughness element.

In a further aspect, each roughness element 20 can have at least one riblet 40 extending outwardly therefrom the front surface 22 of the roughness element. In one aspect, the riblet 40 extends longitudinally from at or near the bottom portion 30 of the roughness element, proximate the base 31, to at or near the top 29 of the roughness element. That is, in one aspect, the riblet extends substantially transverse to the underlying surface. If a plurality of riblets are used, it is contemplated that the ribs can be spaced apart substantially equal or at varying distances. Of course, the number of riblets 40 can vary in number, but typical values would be that from 1 to 7 per each longer wavelength of the saw tooth pattern of the formed ridge of the micro-array. In one aspect, the number of riblets is 1, 3, 5, or 7.

The presence of the riblets 40 formed to either the front surface 22, or, optionally, to both sides of the roughness element, act to give a streamlining effect that is conductive to the formation and stability of the cavity flows (or vortices) embedded within the cavities formed between adjacent ridges or rows of the roughness elements. In one aspect, the addition of the riblets to the roughness elements micro-geometry help to increase drag reduction, such as, for example, with higher speed flows. In a further aspect, the riblets 40 act to excite counter-rotating vortices within the outer vortex structure that when in even numbers (formed by an odd number of riblets) promote the stability of the vortex array in the surface.

Further, in another aspect, it is contemplated that a trough 42 is defined therebetween adjacent riblets 40 that is recessed from the respective tips 44 of the riblets. In one aspect, the trough can be formed by a smooth, curved surface. Of course, it is contemplated that the surface of each of the troughs in the respective roughness element can have a substantially equal radius of curvature or can vary as desired.

In another aspect, the riblets 40 have an edge surface 46 that extends between the respective riblets that are adjacent to the sides of the roughness element. In one aspect, the edge surface 46 can be substantially planar. Alternatively, at least a portion of the edge surface can be curved. In the curved aspect, it is contemplated that the radius of curvature of the edge surface can be greater than the radius of curvature of the troughs 42 of the roughness elements.

It is further contemplated that the geometry of the formed surface can be altered as a function of the thickness of the boundary layer adjacent to the surface. For example, in regions where the boundary layer is thicker, the tops 29 of the roughness elements 20 can also comprise an additional saw tooth pattern of shorter wavelength superimposed on the larger wavelength saw tooth pattern. This is of importance in regions far downstream from the leading edge of a body where the boundary layer is thicker, yet the flow outside the boundary layer and above the surface is of high velocity.

In a drag reduction mode, the saw tooth pattern on the tops 29 of the roughness elements 20 acts to inhibit the formation of the optimal perturbations that appear due to the instability of the shear flow (or boundary layer) above the roughness element and inside the boundary layer. At lower speeds this wavelength is larger. Conversely, at higher speeds this wavelength is smaller. In one exemplary aspect, the smaller wavelength superimposed on the larger saw tooth tops can vary from between about ⅓ to 1/7 that of the larger wavelength. The sizing is a function of the speed of the flow outside the boundary layer adjacent to the surface (U), the kinematic viscosity of the fluid (ν) and the maximum shear in the boundary layer ((du/dy)ₘₐₓ). It should be noted that as a body moves at higher speeds, the boundary layer at a particular point on the body will reduce in thickness and the maximum shear sustained in the boundary layer will increase. This corresponds to a decrease in the wavelength sizing required of the roughness element to act in drag reduction mode.

Regardless of whether a surface results in the formation of embedded vortices within the respective roughness elements or not, the “male protrusions” that result from the roughness elements and their sizing can be sufficient enough to delay the transition to turbulence in the boundary layer and thus still result in drag reduction. However, to maximize the drag reduction characteristic of the micro-array of roughness elements of the present invention would include both the formation of the embedded spanwise vortex array within the roughness element as well as the protrusion geometry of the roughness geometry, which leads to the damping of instabilities in the boundary layer that result in the transition to turbulence.

In addition, and as noted above, the downstream side of the roughness elements can, or can not, comprise a slightly concavity to the surface (see FIG. 7) as well. This thickness to the peak of the formed ridge provides a smooth line of reattachment for the separated shear layer over the top of the cavity from the previous upstream roughness element and at the top of the roughness element provides for a tangential meeting of this outer flow with the next downstream embedded cavity vortex (again, see FIG. 7). All of the elements listed here have to do with the effects of streamlining the micro-geometry to promote the formation of a stable, embedded cavity vortex within the roughness element.

Further, it is contemplated that the micro-array 10 of roughness elements 20 on the surface 2 can comprise a plurality of micro-arrays of roughness elements 20 on the respective surface 2. In this aspect, each micro-array can comprise a plurality of roughness elements, as described above, of a predetermined height and/or shape. Thus, it is contemplated that, the plurality of micro-arrays could comprise arrays of varying sized or shaped roughness elements.

In another aspect, each micro-array of roughness elements can comprise individual roughness elements that vary in respective scale and/or shape. For example and not meant to be limiting, adjacent roughness element could have different relative scaled dimensions. Thus, a “large” roughness element can adjoin a “small” roughness element, such that a front view would be of a line or ridge of the adjoining roughness elements that have a staggered saw tooth appearance.

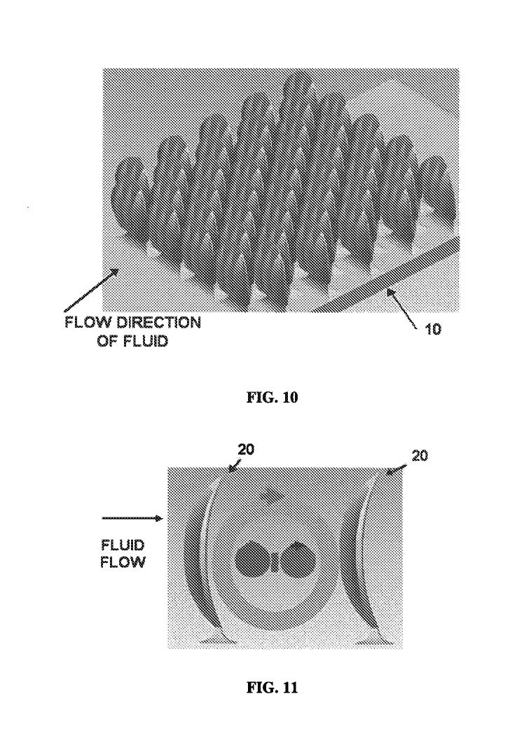

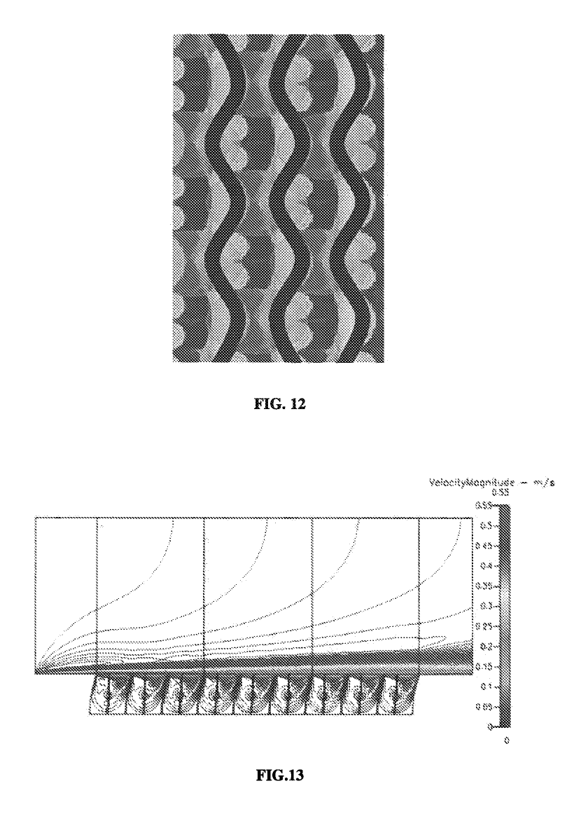

In the arrays discussed above, the formed channel 34 between adjoining roughness elements 20 allows for some of the reversed flow at the bottom of the cavities between adjacent span-wise extending ridges of lines of the roughness elements to head back upstream to the adjacent, neighboring cavity through the channels between the roughness elements. In operation, a cavity flow can result such that fluid particles stay in the cavities to continue the circulatory pattern between the two cavities, i.e., entering the downstream cavity over the top of the valley to return back to the upstream cavity through the gap beneath the valley as shown in FIG. 11. The juncture of the two adjoining roughness elements acts as a center for each individual cavity vortex and can also allow for a secondary pair of vortices to form inside the larger cavity vortex, which is also shown in FIG. 11. Referring to FIG. 12, these vortices, one inside each transverse half cavity, provides a means of interlocking all of the cavity flows together in an almost chain-link type array of streamlines that are relatively stable and are not subject to cavity influx/efflux of flow, which leads to an increase in drag for the d-type surface. As noted above, the micro-geometrical patterning of a surface in this embodiment for maximum drag reduction mode results in the formation of an array of embedded cavity flows (or vortices) between the roughness elements.

It is contemplated that the flow arranged by this roughness element is a series of micro-slip walls in which the orange ovals in FIG. 12 denote each micro-slip wall. From another standpoint, it is contemplated that the roughness element of the present invention alters the no slip condition which the outside flow sees at the wall. Further, it is known that embedded cavity flow can be used as a means of separation control due to the alteration of the no-slip condition at the surface. It is contemplated that the roughness element described herein can be used in applications that would reduce the pressure drag associated with separated flows over surfaces.

In a further aspect of the “roughness” surface, the thickness of the boundary layer can be in a range of at least 10 to 30% of a cavity height of each cavity such that shear layer instabilities of cavity vortexes that form therein the plurality of cavities are reduced. Preferably, the thickness of the boundary layer is about at least 20% of the cavity height. Typically, cavity height would be measured from the surface 2 of the object to the peak or highest amplitude of the roughness elements that form the transversely disposed ridge. In one aspect, each formed cavity vortex can have a Re, relative to the cavity height, velocity of the fluid over the wall surface, and the kinematic viscosity of the fluid, in the range of between 100 and 20,000, such that the instability of the formed cavity vortexes are suppressed. Optionally, each formed cavity vortex can have a Re, relative to the cavity height, velocity of the fluid over the wall surface, and the kinematic viscosity of the fluid, in the range of between 1,000 and 5,000.

The micro-arrays of the roughness elements of the present invention would find applicability in drag reduction modalities, such as, for example and not meant to be limiting, on the surfaces of aircraft, submarines, ship hulls, high speed trains and the like. In the case of the flow over the hull of a ship, the micro-arrays of the roughness elements can impact the boundary layer formation over the hull and therefore affect the amount of air ingested below the water line, thereby altering the entire flow field of a ship's wake. It is also contemplated than the micro-arrays can be used in pipeline walls as well, which would result in a large reduction in the amount of energy saved to pump fluids from one point to another.

It is also contemplated that the micro-arrays of the present invention allows for the trapping of pockets of air inside the cavities such that, for example, in hydrodynamic applications, the working fluid for the micro-slip walls would consist of these air pockets. This would also reduce the skin friction for hydrodynamic applications and, in another aspect, can reduce cativation.

Still further, the micro-arrays of roughness element can act as a means of controlling separation. The effect of the arrays acts to reduce pressure drag over bluff bodies such as automobiles and trucks. It can also minimize separation over turbine blades, airfoils, and helicopter rotors as well as flow through serpentine ducts, which is often a requirement for inlet geometries for engines on an aircraft. Optionally, in a drag enhancement mode, a surface formed with the micro-array of roughness elements of the present invention allows for highly effective convective cooling to the surfaces of computer board components, which could greatly impact the performance of these devices.

It is also contemplated that the self-cleaning property of the roughness elements should be excellent due to the high shear rates resulting over the major portions of the surfaces of the roughness elements. However, it is also contemplated to use hydrophobic materials in constructing the roughness elements for hydrodynamic applications.

It is contemplated that a surface formed with a micro-array of roughness element as described above, could be formed for a saw tooth wavelength that corresponds to that of the optimal perturbation wavelength for the shear flow inside the boundary layer. In this example, the alignment or alternation of the peaks to achieve maximum heat transfer rates and maximum drag at a surface is considered. In one aspect, the alternation of the peaks forces the half-wavelength of the saw tooth amplitude to correspond to the optimal perturbation wavelength. Thus, it is contemplated that the formed drag reducing surface could become drag enhancing as the flow speed is increased.

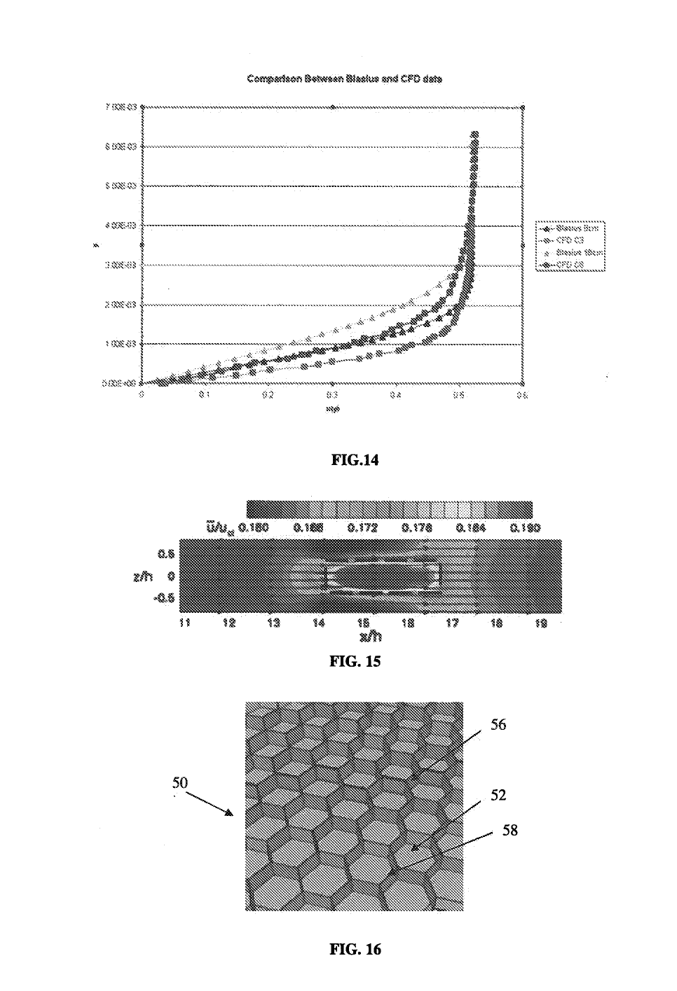

Referring now to FIGS. 15-18, in an alternative embodiment, a method for reduction in skin friction drag comprises an array of three-dimensional micro-cavities that are configured to form an array of stable, embedded cavity vortices such that a three-dimensionally patterned partial slip condition is produced over the surface. This complex boundary condition passively forces the boundary layer flow and results in sub-laminar skin friction. In another aspect, the formed boundary condition can act to delay transition to turbulence within the boundary layer.

Reduction in skin friction drag over a surface can be achieved by delaying the transition of the boundary layer from the laminar to turbulent state. This is due to the fact that a laminar boundary layer has significantly lower shear stress at the surface than a turbulent one, and attempts to delay transition are labeled as laminar flow control (LFC). The typical method to maintain laminar flow is through the use of suction. Alternatively, discrete roughness elements (DRE) can be used. It has been found that, through the use of small cylindrical DRE strategically located on the surface of a plate, Tollmien-Schlichting (TS) instability waves that are known to lead to natural transition in a flat plate boundary layer can be suppressed. This can be achieved due to the formation of steady, optimal low and high speed streaks across the boundary layer of moderate amplitude, which are found to suppress the instabilities forming on the TS waves that lead to the formation of turbulent spots. It has also been shown that roughness elements, spaced with spanwise wavelengths shorter than that corresponding to the most amplified disturbance in the boundary layer, can act as a means of delaying transition in the case of swept wing boundary layers whereby the cross-flow instability is suppressed.

It is contemplated that the negative effect of enhanced receptivity for a two-dimensional ribbed roughness that is typically observed can be attributed to the amplification of TS instability waves by a periodic 2-D forcing from variation in the shear stress as the flow passes over the tops of the roughness elements. In one aspect, it is contemplated that a 3-D periodic forcing can be imposed by the roughness elements. In another aspect, significant sub-laminar drag over the surface can be achieved by minimizing the separation distance between the cavities (with the surface being substantially structurally sound). Further, the methodology can act to reduce the boundary layer receptivity and delay transition. In one preferred aspect, the surface is specifically patterned to facilitate interference with the growth process of the most unstable waves.

In one aspect, the methodology contemplates the use of a cavity having a substantially constant depth. The constant depth cavity helps to form and maintain a stable cavity flow, with no influx/efflux of fluid.

In another aspect, a microgeometry 60 is formed in the surface that is exposed to the flow of fluid. In one example, the microgeometry can comprise a three-dimensional array 50 of micro-cavities 52 such that the cavity Re remains small (about on the order Re=2000) and the boundary layer forming over the cavity is sufficiently thick. Such a formed microgeometry insures that the centrifugal instability, leading to the formation of Taylor-Gortler vortices, in the cavity flow as well as any instability of the shear layer (Kelvin-Helmholtz instability) forming over the cavity openings is prevented. The result is a stable cavity flow, with no influx/efflux of fluid. The resulting partial slip condition, formed at the boundary separating the cavity flow fluid and outer flow fluid, results in reduced momentum thickness within the boundary layer.

In one experimental example, the alteration of the momentum thickness was confirmed and resulted in a reduction of drag coefficient at a distance 18 cm downstream from 0.01736 for the Blasius solution to 0.00415 sustained over the first eight cavities (75% reduction).

In various aspects, it is contemplated that the cavities of the microgeometry can comprise a substantially cubic design, a honeycomb structure, as shown in FIG. 16, and the like. These shapes are merely exemplary and no limitation on the geometric shape of the cavities of the surface is intended.

In another aspect, a method/system for facilitating a controlled point of transition in the boundary layer and/or delaying transition is provided. In one aspect, a plurality of discrete roughness elements (DRE) can be spaced in the spanwise direction of the surface at the optimal wavelength. This structure can cause streamwise vortices and low-speed streaks of sufficient amplitude (such that breakdown to turbulence will take place over a flat plate) to be generated through the transient growth mechanism.

In another aspect, a small spanwise slit is provided in the surface through which, via an alternation of suction and pumping of fluid, TS waves in the most unstable frequency range can be generated that lead to early transition. In still another aspect, an adverse pressure gradient for the flow over the boundary layer is set up such that early transition is promoted. This can be exemplarily achieved by placing the flat plate surface at a small angle of attack relative to the flow of fluid such that the flow over the flat plate is subjected to a diverging area and subsequently decelerates along the length of the plate.

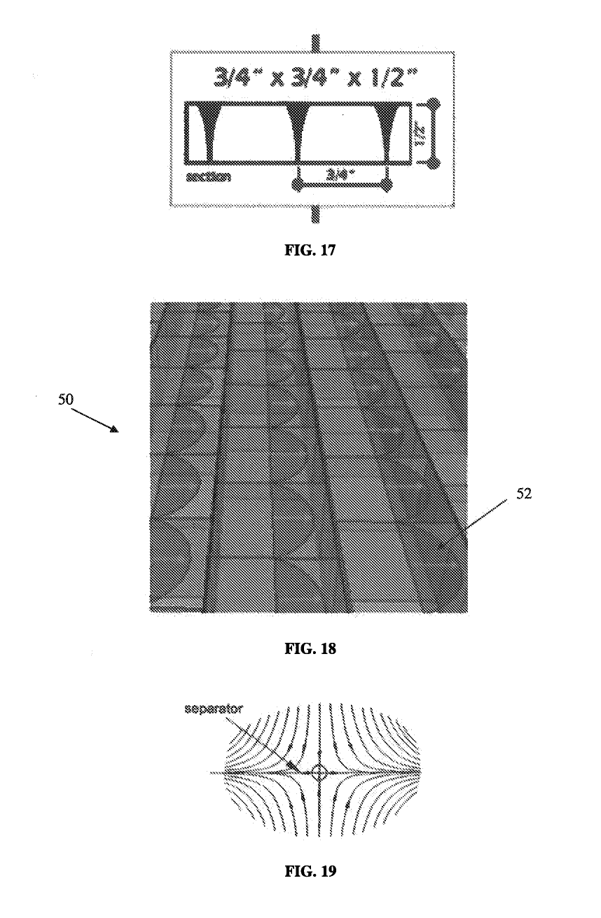

One exemplary example of a three-dimensional array 50 of micro-cavities 52 embedded in the surface is shown in FIG. 18 for an offset, square patterned micro-cavity field. It is contemplated that this complex partial slip condition pattern can be configured, via the geometry and sizing of the cavities, to disrupt the formation of high and low speed streaks in the near wall layer that lead to the transition to turbulence in the boundary layer. In one aspect, the partial slip pattern favors the streamwise direction, and according to the computations of Min & Kim (2005), a surface dominated by streamwise slip has the highest potential for transition delay. Thus, the microgeometry disrupts the formation of the low-speed streaks and reduces the momentum thickness of the boundary layer. It should be noted that this higher momentum in the flow closer to the surface is favorable also in delaying separation of the boundary layer under adverse pressure gradient conditions (Gad-el-Hak, 2000).

This embodiment thus contemplates the use of a microgeometry 60 that can comprise an array 50 of cavities 52 in which embedded cavity flows form. The array 50 of cavities 52 can be configured to cause transition delay in boundary layer flows and to reduce skin friction drag. It is contemplated that the methodologies/systems of the present application that use such an embedded micro-cavity surface lead to sub-laminar boundary layer skin friction coefficients and correspondingly smaller momentum thickness. Of course, while two primary cavity geometries, cubic and hexagonal, have been discussed herein, it is contemplated that these shapes are not meant to be limiting and that other geometric shapes can be used (perhaps in combination).

In a further aspect, at least a portion of the edges 54 of cavities 52 that are substantially aligned with the flow of fluid over the surface can have upwardly extending ribs that are connected to and extend outwardly from the top edges 58 of the cavity. In another aspect, portions of a plurality of cavity walls 56 of the cavities can extend upwardly above the generalized plane of the surface to form wall extensions. In one aspect, the wall extensions can protrude into the flow of fluid above the plane of the surface only on those cavity walls 56 that were aligned with the fluid flow direction. Optionally, the wall extensions could extend partially or along the substantial length of the portion of the cavity walls that are aligned with the fluid flow direction. Further, the height of the wall extension above the generalized plane of the surface can be a multiple of the depth of the cavity. It is contemplated that this multiple can range between about 0 to about 4. It is also contemplated that the outwardly extending extensions or ribs would be beneficial in inhibiting cross-flow near the surface and perhaps cavity influx/efflux.

In one aspect, it is known that separation of the boundary layer from the body typically occurs in vicinities where the flow is decelerating due to change in body curvature, which results in an adverse pressure gradient. Thus, separation typically occurs in areas that are posterior of the maximum body thickness. Incipient separation is characterized by regions of decreasing skin friction approaching zero, and consequent reversal of the flow at the surface A similar process, known as dynamic stall, characterizes unsteady separation from a moving surface producing lift (i.e., a pitching airfoil) or thrust (i.e., an oscillating caudal fin). Unsteady separation is characterized by a locality where both the shear stress (or skin friction) and velocity approach zero as seen by an observer moving with the separation point (known as the MRS criterion). In this case, a separated region is most likely to occur near the point of highest curvature (typically near the leading edge) prior to blending with the wake near the trailing edge. If such separation occurs in the latter case, lower propulsive efficiencies typically result. However, if the unsteady separation process can be controlled, such that the leading edge separation bubble remains disconnected with the wake then an unsteady high-thrust (or high-lift) generation mechanism can occur.

In another aspect, when three-dimensionality is added to the separation flow kinematics, the boundary layer separation does not always coincide with a point of zero shear stress at the wall. In fact, and as shown in FIG. 19, the shear stress can vanish only at a limited number of points along the separation line, and a convergence of skin-friction lines onto a particular separation line is required for separation to occur. As a result, 3D boundary layers can be more capable of overcoming an adverse pressure gradient without separating. Thus, in this embodiment, it is contemplated that the respective micro-geometries of the micro-array of roughness elements are configured in a preferential flow direction. This configuration can prevent the required convergence of skin friction lines and can passively act to keep the flow attached, thereby reducing pressure drag.

As contemplated, delaying separation of the flow from a solid boundary results not only in reduced pressure drag, but also decreased pressure losses in ducted flows such as through diffusers and turning elbows. Various mechanisms by which separation can be controlled have been investigated and successfully applied in the past. Many of these techniques require the application of suction and/or blowing at the surface and require energy input.

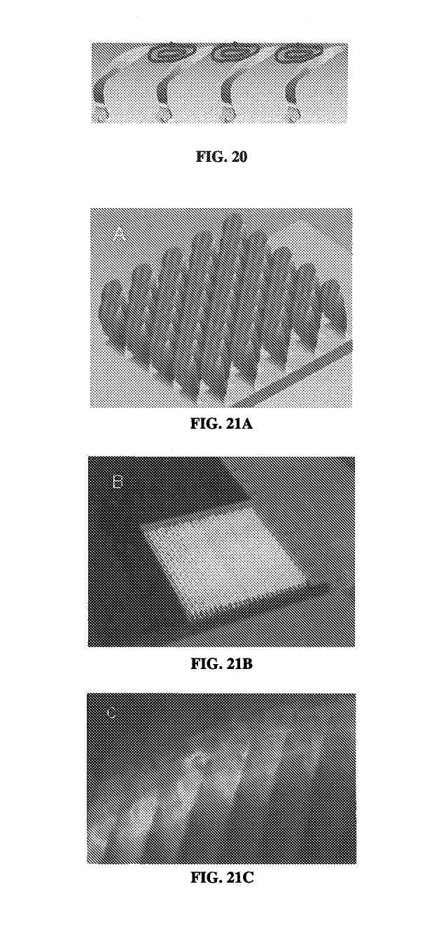

The micro-geometries of each of the roughness elements can be configured to successfully control separation. In this aspect, the micro-geometries act to impart momentum to the very near-wall region of the flow, which prevents flow reversal. This can be achieved by the formation of embedded cavity vortices as shown in FIG. 20. One of the most successful passive means to date has been the use of vortex generators, or small typically v-shaped protrusions with profiles less than half the boundary layer thickness. These have been shown to produce a system of streamwise vortices which mix high and low momentum fluid that energizes the flow close to the surface. Vortex generators need to be placed at a specific downstream location within a turbulent boundary layer for maximum performance such that the streamwise vortices affect the region where separation would normally occur.

As described above, patterned surfaces can also result in separation control and golf ball dimples present one of the most well-known illustrations of surface patterning resulting in separation control and reduced drag. However, the dimples do more than just trip the boundary layer to the turbulent state. It has been shown that the formation of embedded cavity vortices, or small localized regions of separation within the surface allow the outer boundary layer flow to skip over the dimples in the pattered surface. Thus, the use of patterned surfaces, capable of imposing partial-slip flow conditions at the wall due to the formation of embedded vortices, can achieve drag reduction via separation control.

In addition, and as contemplated herein, if a surface has a preferred flow direction, which can exemplarily be felt by moving one's hand over the surface, movement in the direction of preferred flow would feel smooth to the touch. But, when the preferred direction surface is felt in the opposite direction, a higher resistance is imposed and the surface feels rougher. Thus, this aspect acts to enhance the boundary layer control mechanism of the micro-geometries by providing a preferential flow direction of the surface that is capable of locally resisting the reversal of flow at or near the surface. Therefore, the configured surface has the potential to disrupt the convergence of skin-friction lines onto a particular separation line, which controls three-dimensional separation. The contemplated micro-array of roughness elements, with the exemplary preferred flow direction micro-geometries can aid in separation control and or transition delay.

Flow experiments have been conducted on an exemplary model array surface, shown in FIGS. 21A and 21B. In this exemplary array of roughness elements, a 16×24 array of roughness elements were scaled up from 0.2 mm to 20 mm for the model. Similarity of the cavity flow is achieved by matching the cavity Re˜2800 between real application at higher velocities and model (the scale-up in size is countered by a scale-down in velocity over the surface from 14 m/s to 14 cm/s with negligible change in viscosity). In one experiment, a long flat plate (˜180 cm) with an elliptic leading edge was used to grow the boundary layer sufficiently thick such that shear layer instabilities over the cavity vortices were not observed to develop. It has been shown that a vortex forming in a square cavity remains stable at Re=10,000 as long as the boundary layer thickness was more than roughly 20% of the cavity depth.

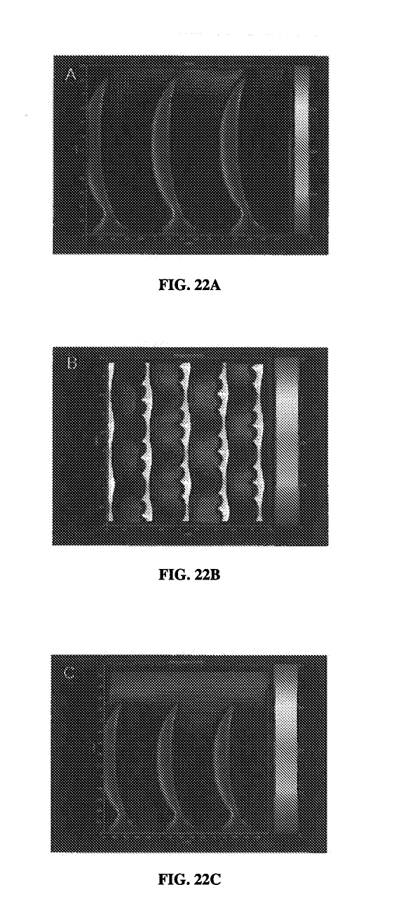

Referring to FIG. 21C, the experimental results confirmed the presence of cavity vortices within the micro-array. The results also show that with the sufficient growth of a boundary layer upstream of the model (local Re=2×10⁵), transition is not tripped by the surface and the flow skips over the cavities. Referring now to FIG. 22A-22C, a time-resolved digital particle image velocimetry system was used to capture 2D velocity data within and above the exemplified micro-array surface. In FIG. 22A, the middle roughness element corresponds to a valley in the configuration geometry, and the first and third elements to peaks. In this exemplary aspect, the flow accelerates over the cavity spanning the first and third denticles or roughness elements, with the primary formation of vorticity being measured in front of the third denticle (flow being from left to right in the figure). In this example, and as shown in FIG. 22B, the flow accelerates as it passes over the cavity between the denticles and reaches speeds on the order of 5-10% of the freestream flow (U) and has an average velocity in the y=0 plane of 0.03U. In the purely flat surface case, the no slip condition at y=0 enforces a zero velocity boundary condition to the boundary layer flow.

It is contemplated that the flow velocity at the streamline separating the cavity flow from the outer boundary layer flow will further increase concomitantly with a decrease in the boundary layer thickness (in the current exemplary case this is about 21 mm, or roughly the same size as the cavity depth and thus a fairly thick boundary layer is used for these results). In the case where the boundary layer is tripped prior to the configured denticle model this increases to an average velocity in the y=0 plane of 0.14U as a result of the higher momentum closer to the surface from the presence of the turbulent boundary layer above the denticle model. As shown in FIG. 22C, periodic exchange of fluid is observed in the turbulent boundary layer case between the cavity flow and boundary flow, but on average the flow displays only a streamwise component above the cavity. These results are consistent with the cavity flow exchange observed in two-dimensional transverse ribbed surfaces. Thus, it is contemplated that a micro-array of erect roughness elements leads to higher momentum in the fluid at y=0 for both laminar and turbulent boundary layer conditions which makes such a roughness surface a good candidate as a mechanism for separation control.

In one aspect, it is contemplated that the roughness elements described herein can be positioned at an angle relative to the flow of fluid across the roughness surface. The example shown in FIG. 22A illustrates an exemplary roughness element that is extending substantially normal to the flow of fluid. It is contemplated that the roughness element can be positioned at a selected angle or angles relative to the flow such that a preferential flow direction surface is formed.

Positioning the roughness elements at more acute angles will result in shallower cavity areas that are conducive to embedded vortex formation within the geometry. As the angle increases toward normal, the inter-element cavity distance between the roughness elements increases. FIG. 20 shows the theorized cavity vortices which should form between adjacent roughness elements for angled configurations. The vortices that form can be more shallow and oblong in nature than previously reported. Yet, even in very shallow circular depression roughness, such as dimples on a golf ball, the existence of a cavity vortex is found to occur even at low Re. It is postulated that the primary mechanism by which separation control is achieved is the partial slip over the embedded cavity vortices. However, small-scale mixing of fluid into and out of the cavities can also provide an additional mechanism delaying or preventing separation for turbulent or transitioning boundary layer conditions.

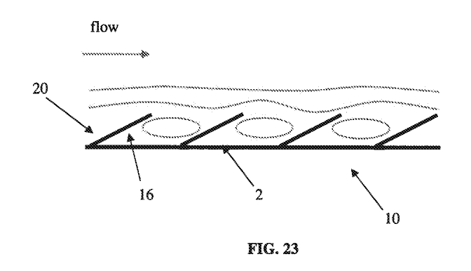

In another aspect, as illustrated in FIG. 23, at least a portion of the plurality of roughness elements 20 can extend at an acute angle relative to the underlying surface 2. In another aspect, the plurality of roughness elements 20 can extend at an angle of between about 5 degrees and 85 degrees relative to the underlying surface. In another aspect, the plurality of roughness elements can extend at an angle of between about 30 degrees and 60 degrees relative to the underlying surface 2. In still another aspect, the plurality of roughness elements 20 can extend at an angle of about 45 degrees relative to the underlying surface.

In one aspect, it is contemplated that positioning at least a portion of the plurality of roughness elements at an acute angle relative to the underlying surface can potentially create a larger cavity 16 than a plurality of roughness elements positioned substantially normal to the underlying surface. In another aspect, for air flow over the plurality of roughness elements on the order of 2 m/s, the Re can be calculated to be on the order of 10 based on cavity length, as can be appreciated.

In still another aspect, the boundary layer thickness at a distance of approximately 0.5 cm from the leading edge of an array 10 of roughness elements 20 can have Re=700 and δ=1 mm at a fluid speed of approximately 2 m/s. In another aspect, the boundary layer thickness at a distance of approximately 5 cm from the trailing can have Re=7×10³ and δ=3 mm at a fluid speed of approximately 2 m/s. Thus, it is contemplated that an embedded geometry with cavities on the order of 1/10^{th} the boundary layer thickness can interact with the viscous shear flow occurring at the surface of the array of roughness elements.

In this embodiment, at lower Re, the array 10 of roughness elements 20 extending at an acute angle relative to the underlying surface can be arranged substantially linearly such that a plurality of spanwise channels comprise the embedded cavity. In one aspect, the angled roughness elements can also be substantially aligned in the streamwise direction (i.e., not staggered). In another aspect, the plurality of roughness elements can also be arranged to give the path of least resistance to the flow over the surface, as illustrated in FIG. 23. As can be appreciated, because of the lower Re and laminar flow above the cavities, the cavities can have a length greater than their heights and still form a stable, embedded vortex, thereby helping to maximize the skin friction reduction potential.

In another aspect, however, it is contemplated that the roughness elements 20 can be aligned such that the peaks of the roughness elements of each adjacent ridge 12 can be staggered, as previously discussed, giving the surface a three-dimensional yet repeatable pattern. This can, in one aspect, create a roof shingle-like pattern of roughness elements that can allow adaptation to a curved, irregular underlying surface.

In another aspect, an array of roughness elements can be disposed on and extend therefrom the underlying surface. In this aspect, the roughness elements can be positioned substantially transverse to the flow of fluid across the wall surface, and substantially linearly in successive ridges of roughness elements. In another aspect, a plurality of embedded cavities can be formed therebetween the successive ridges of roughness elements and the flow of fluid across the wall surface can form at least one cavity vortex therein each cavity of the plurality of embedded cavities.

In another aspect, the roughness elements of successive ridges can be offset in a direction substantially parallel to the direction of fluid flow on the at least a portion of the wall surface. Alternatively, the roughness elements of successive ridges can be aligned in a direction substantially parallel to the direction of fluid flow on the at least a portion of the wall surface.

In another aspect, re-aligning the geometry can increase surface drag under reversed flow (such as in the case of a leading edge vortex or separation region). In another aspect, when the roughness elements are aligned transverse to the fluid flow, the surface drag can be reduced below that of a flat surface.

In one aspect, the angle between the plurality of roughness elements and the underlying surface can allow for a preferential flow direction to the surface 2. In another aspect, it is contemplated that the surface 2 can aid in controlling the unsteady flow and leading edge vortex formation occurring over the array 10 of roughness elements that would occur, for example, during flapping flight. Moreover, in this role, it is contemplated that the surface can also aid in preventing separation at the trailing edge of the array of roughness elements 20, thereby resulting in longer attachment of the leading edge vortex (without stall) and higher lift and thrust production. Thus, for example, this microgeometry can be useful on the wings of flapping micro-air vehicles (MAVs) and the like.

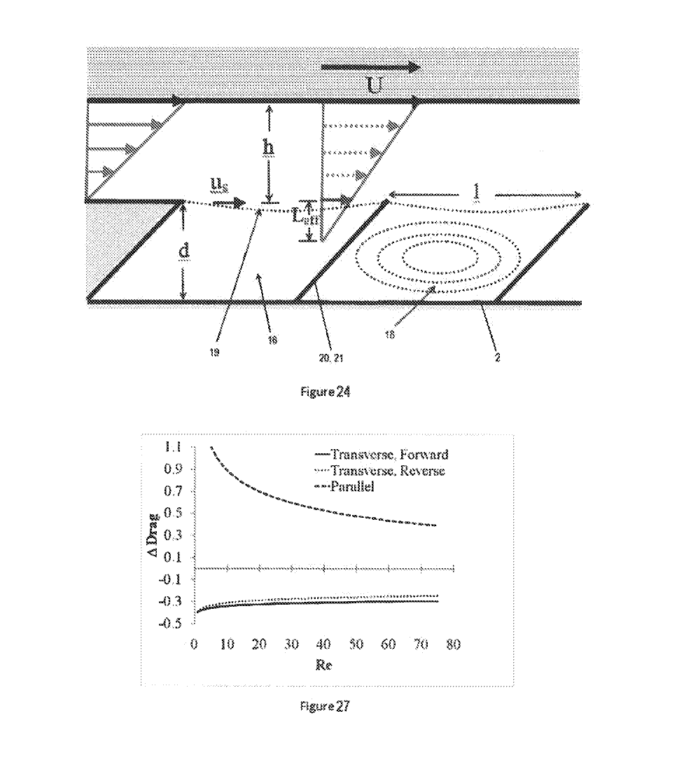

Referring now to FIG. 24, in one aspect, a system and method for reduction in skin friction drag comprises a plurality of three-dimensional cavities 16 that are configured to form a plurality of stable, embedded rotating cavity vortices 18 such that a partial slip condition is produced over the surface 2. A dividing streamline 19 can be formed between the trapped flow of the embedded vortices 18 and the outer fluid flow passing over the cavities 16.

In one aspect, the methodology contemplates patterning the surface 2 with a plurality of roughness elements 20 such that cavities 16 are formed on the surface between successive roughness elements with minimal spacing between the cavities. In another aspect, it is contemplated that the roughness elements described herein can be positioned at an angle relative to the flow of fluid across the surface such that a cavity is formed downstream of each roughness element. In still another aspect, the cavities could be formed in rows of varying spans to conform to a curved, three-dimensional surface if necessary. In another aspect, the cavities 16 can be formed such that a flow of fluid relative to the surface can pass transversely over the rows of cavities.

If the surface 2 begins to move within a stagnant fluid, or if the fluid begins to move relative to the surface, in one aspect, each roughness element 20 of the plurality of roughness elements can be sized and shaped so that each respective cavity 16 can develop an embedded rotating vortex 18. In one aspect, each cavity vortex can contain a predetermined volume of the fluid rotating therein the cavity. In another aspect, the plurality of roughness elements 20 can be sized and shaped so that the volume of fluid therein each cavity vortex 12 is substantially constant as fluid flows relative to the wall surface 2. That is, although there can be some leakage of fluid form the vortex, and/or the addition of some fluid to the vortex, at a predetermined flow rate of the fluid relative to the surface, the volume of fluid rotating in the embedded vortex 18 can be substantially constant. For example and with reference to FIG. 24, the presence of the rotating vortex 18 embedded in the cavity 16 can restrict fluid flowing over the cavity from entering into the cavity. Furthermore, the rotating vortex can restrict the amount of fluid leaving the cavity.

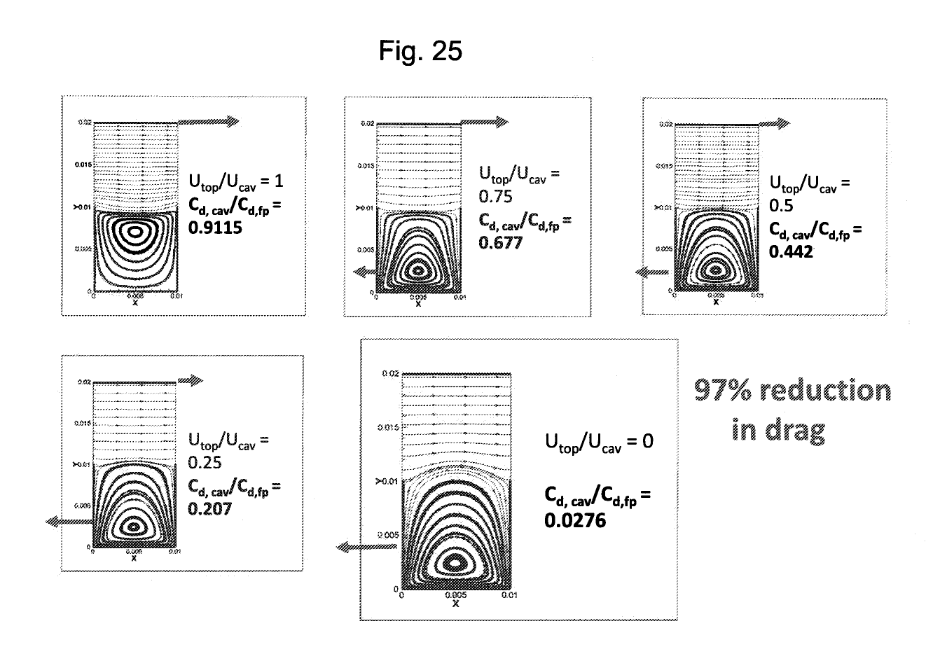

At a predetermined fluid flow rate relative to the wall surface 2, in one aspect, a least a portion of one embedded vortex 18 can bulge up and out of the cavity 16. In another aspect, at a predetermined fluid flow rate relative to the wall surface, at least a portion of the rotating cavity vortex can have a vortex height greater than a depth of the respective cavity. For example, see FIG. 25 which illustrates the changing shape of the embedded vortex as fluid conditions change. This vortex can act as a “rollerbearing” to form a fluidized bearing surface to alleviate the no-slip condition and reduce friction between the fluid and the wall surface. However, in order for this rollerbearing mechanism to work, fluid should be trapped and maintained within each cavity. Again referring to FIG. 25, assuming Re=5 and the surface is moving in stagnant air at 3 m/s, and a cavity depth of about 30 microns, this rollerbearing mechanism can lead to a partial slip of about 0.03 times the speed of the cavity, or about 97% reduction in drag relative to a flat plate.

In one aspect, to maintain the trapped vortex requires that the local Re=Ud/ν (where U is the speed of the surface, d is the cavity depth, and ν is the kinemtic viscosity of the fluid moving relative to the surface) remain low enough such that stability of this vortex is maintained. In another aspect, it is contemplated that a Re<50 will prevent the trapped vortex from becoming unstable which could otherwise cause fluid to enter and leave the cavity. The shear forces in this viscous flow can induce a motion of the fluid that causes the least amount of resistance. In one aspect, the motion of the fluid takes the form of rotation of the fluid within the cavity as a whole, or the formation of a cavity vortex 18. In another aspect, the rotating vortex can sustain the majority of the velocity gradient between the moving surface 2 and the fluid in which the surface is moving.

In another aspect, the center of the rotating vortex 18 can be quickly relocated towards a bottom of the cavity 16 with even minimal motion of the surface, as illustrated in FIG. 25. This can result in a substantial reduction in the size of any boundary layer forming within the outer fluid. In yet another aspect, for a streamlined body (i.e., no sharp corners) the net result when applied to a moving surface can be the elimination of boundary layer transition and subsequent higher drag, as well as the prevention of flow separation. Flow separation can be prevented due to the fact that large partial slip velocities occur at the surface 2 as opposed to a no slip case. The effect can be reduced if the surface moves into an oncoming flow of fluid, however even for the case where the flow has equal speed to that of the surface a greater than 50% reduction in drag can still occur.

Cavity shapes can vary as long as a stable, embedded cavity vortex 18 is maintained within the cavity 16. In one aspect, to maximize the rollerbearing effect, roughness elements 20 forming the cavity walls 21 can have minimal contact, or surface area, with the outer fluid through which the surface is moving. For example, each cavity can have an aspect ratio (“AR”, defined as length of the cavity relative to cavity depth) of about 0.1, 0.2, 0.3, 0.4, 0.5, 0.6, 0.7, 0.8, 0.9, 1.0 1.5, 2, 3, 4, 5, 6, 7, 8, 9, 10 or greater than 10. In another aspect, each cavity 16 can be shaped and sized to minimize the number of cavity walls over a given length of body surface 2.

In one aspect, a longitudinal axis of each roughness element 20 forming the cavity walls 21 can extend substantially normal to the underlying surface 2. In another aspect, at least a portion of the cavity walls can extend at an acute angle relative to the underlying surface. In another aspect, the cavity walls can extend at an angle of between about 5 degrees and 85 degrees relative to the underlying surface. In another aspect, the cavity walls can extend at an angle of between about 30 degrees and 60 degrees relative to the underlying surface 2. In still another aspect, the cavity walls 21 can extend at an angle of about 26 degrees or about 45 degrees relative to the underlying surface.

The roughness elements 20 forming the cavity walls 21 can be substantially planar, in one aspect. In another aspect, and as previously discussed, at least a portion of the roughness elements 20 can be curved (for example, sinusoidal) or trapezoidal shapes and the like. In another aspect, a portion of the roughness elements can be substantially planar, and a portion of the roughness elements can be curved away from the planar portion.

### EXPERIMENTAL

To test if a surface covered with cavities, modeled after the geometry of scale placement found on butterfly wings, could alter the drag two steps were needed. First, the geometry of the scales (nominal scale size on most butterflies is about 100 μm) was confirmed by microscopy. Simplified models were constructed to measure surface drag in a dynamically scaled experiment while at the same time a simple 2D computational analysis was also performed.

Live and dead specimens of Monarch (D. plexippus) were studied with a focus on obtaining a side-view, or sagittal cut, through the wing to observe the cavities formed between the rows of scales. First, observations were focused on whether the scales were moveable or fixed in place, and when air was passed over the surface in multiple directions at speeds in excess of 4 m/s no movement of the scales was observed.

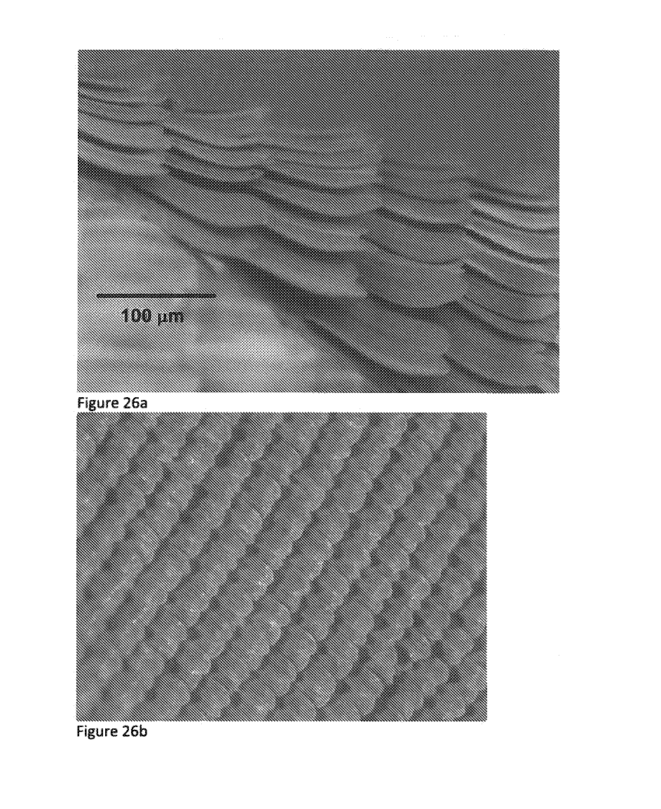

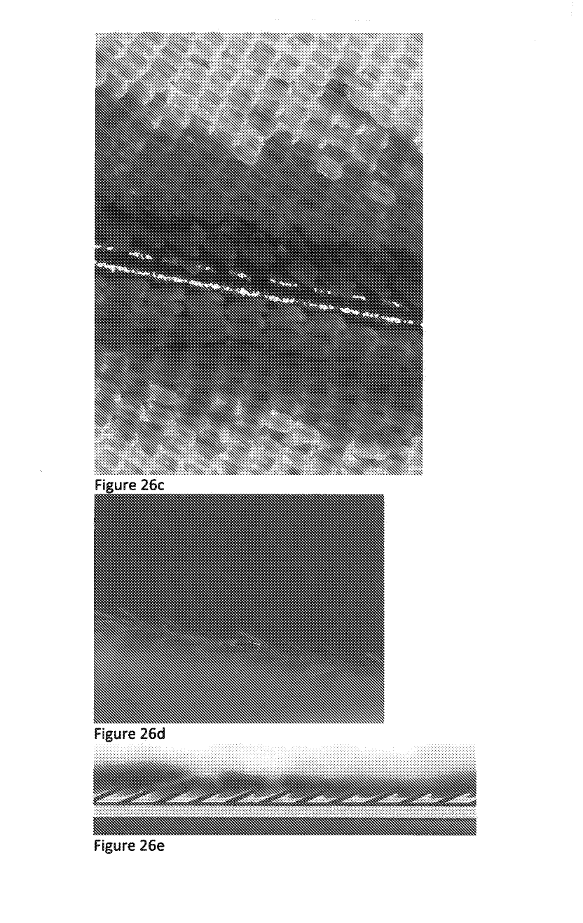

Observations using both optical and scanning electron microscopes (“SEM”) resulted in two separate models of the scale geometry, which differed from previous work by others. As shown in FIG. 26a-26e, the curved or cusped nature of the scales as well as their roof-like shingle pattern with all rows of scales forming perpendicular to the veins was observed on the wings. The scale geometry was modeled by a cavity with a flat bottom and angled side walls specified using cavity depth, d, and total cavity length, l, such that the aspect ratio, AR, was defined as AR=1/d (as illustrated in FIG. 24). One measurement, with such a geometry superimposed over the microscopic image of butterfly scales, illustrated in FIG. 26e, revealed a cavity with an AR of about 2 and a wall angle of about 45 degrees. Other SEM studies suggested an AR of about 3 and a wall angle of about 26 degrees. It is contemplated that the difference in these two models can arise from either a variation in geometry of the scales themselves with respect to wing location and/or specimen as well as the difficulty associated with obtaining a true perpendicular cross-sectional cut of the wing (shown in FIG. 26d). These two models also allow for any differences to be quantified in the results due to geometrical variation.

All testing of the models was completed under Couette flow conditions which allowed for ease of the computational work (self-similar with inlet and outlet conditions matching) and use in an existing facility for drag measurements. The Couette flow velocity profile was linear, as illustrated in FIG. 24 and models the viscous boundary layer profile in the region close to the wing up into which the scales protrude.

Models for experimental testing were fabricated out of Plexiglas with thin aluminum plates to form the cavities such that fabricated surfaces were about two orders of magnitude larger (d=1 cm) than that observed on the butterfly (d˜30 μm). These models (plates measured 66 cm long by 30.5 cm wide with 60% of the area in the middle consisting of cavities) were tested in a Couette flow oil tank facility for measuring surface drag where high viscosity oil is induced to flow inside a gap formed between the model plate and a rotating conveyor belt. A force gauge was used to measure the drag and upon correction of the data was compared directly to that measured over a flat plate model. For the 45 degree case, the drag was measured for flow passing in the transverse direction to the cavities (both forward flow as shown in FIG. 24, and reverse) as well as parallel to the rows of cavities using an additional model for this flow orientation.

The velocity profile between the two walls for a Couette flow was linear, due to the formation of laminar flow for Reynolds numbers lower than about 300; here Reynolds number is defined as Re=Uh/ν where h is the gap height or distance between the walls. Additional parameters used to describe the flow include non-dimensional gap height, β=h/d, a non-dimensional slip velocity η=uₛ/U, and the non-dimensional effective slip length, λ=L_{eff}/h. The drag coefficient over a flat plate where the only surface drag is that due to skin friction is given theoretically as C_{D}=2/Re and thus becomes linear on a log-log plot. The fractional drag coefficient increase or decrease, which is also directly proportional to the actual drag change, from that of a flat plate is thus quantified as:

$$Δ D = \frac{{C}_{D , model} - {C}_{D , flat}}{{C}_{D , flat}} \qquad ( 1 )$$

Thus, ΔD<0 indicates a drag decrease and ΔD>0 indicates a drag increase. The results from the experimental testing are shown in FIG. 27. Trends in the data show the larger drag reduction at lower Re, and that forward and reverse flow over the cavities yielded only a slight difference with the reversed flow case showing less drag reduction. Also, as speculated, for flow passing parallel to the rows the surface drag was increased, and in fact almost doubled at lower Re. This drag increase dropped off with an increase in Re. Further, the higher AR case with the 26 degree cavity walls yielded greater drag reduction than the 45 degree, lower AR case. It is contemplated that the optimal cavity geometry for the formation of trapped, embedded vortex that fills the cavity is an elongated cavity length to minimize the number of times the flow passes over a cavity tip in a given length. Both these effects can maximize the effective average partial slip velocity for flow passing over the cavity geometry.

A 2D, self-similar Couette flow simulation using ANSYS was carried out for two purposes: 1) to document the vortex formation occurring within the embedded cavities for the transverse cases; and 2) to document the dividing streamline between the trapped flow and outer flow passing over the cavities as a function of Re. The average height of this streamline is needed in order to correct the drag reduction data so that the drag reduction obtained under Couette flow can be directly compared to that which would occur in an unbounded flow domain. Lastly, the simulation also allowed for the case where the plate with cavities was moving instead of the flat surface as occurs during the experiments. Any variation due to this effect, because a butterfly for the most part moves through stagnant air and not the other way around, could also be observed.

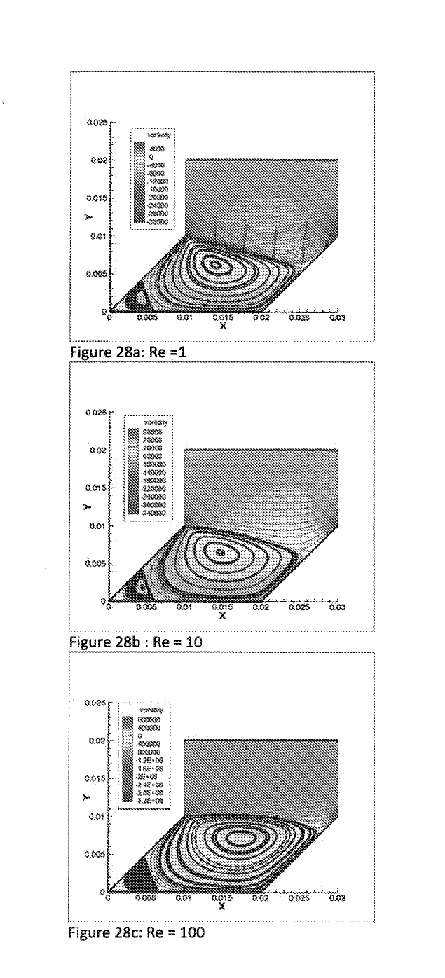

Simulations were performed for the same geometries that were tested experimentally. The streamline and vorticity contours (FIGS. 28a-c) confirm the presence of an embedded, clockwise rotating vortex inside the cavity, when flow proceeds from left to right. The result is that there is now a non-zero velocity distribution at the top of the cavity. In a regular Couette flow, a wall would be located at the cavity tips upon which a no-slip condition would be imposed. The embedded vortex leads to the formation of a partial slip condition instead imposed upon most of the outer flow passing above the cavity. In one aspect, the flow trapped within the cavity becomes inherently part of the surface leading to the so-called “roller bearing effect”.

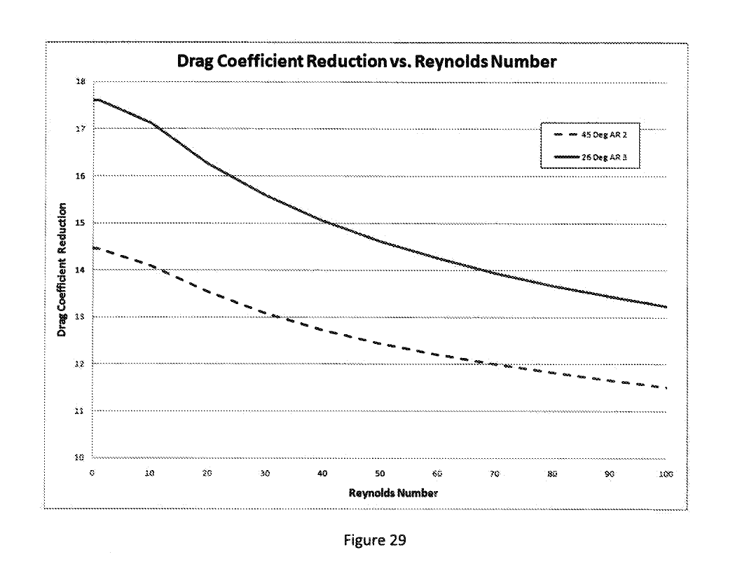

The drag reduction due to this effect calculated computationally for a 2D self-similar viscous flow is shown in FIG. 29. At first glance, it is clear that drag calculations using the 2-D computational model resulted in a drag reduction of about half that measured in the experiments. However, it should be noted that the trends in the data are very similar in that both show a similar decrease in drag reduction with increase in Re, and that there is only a slight decrease in drag reduction for flow in the reverse direction over the cavities. For instance, there is some three-dimensional nature of the flow or a relaxation effect in the drag over the flat part of the plate within in the experiments not covered containing cavities. Also, a limited number of transient simulations revealed that at very low Re (<100) the embedded vortex stopped and started almost instantly, due to the very viscous nature of the flow, over a starting and stopping timescale comparable to that occurring in flapping flight for a butterfly (about 10 ms per flapping cycle).

The drag reduction values shown above in both the experiments and computations are overpredicting the drag reduction that would occur for an unbounded, viscous flow passing over a butterfly wing. The experiments were unable, due to limitation in optical access, to document the flow inside the cavities. However, the computations allow for the calculation of the dividing streamline that separates the flow that is trapped within the cavity and the outer flow passing over the cavity surface. In bounded Couette flow, the argument exists that a drag reduction can be achieved in the case of a flat surface by just increasing the gap height. As shown in FIGS. 28a-c, as the Re increases, the embedded vortex grows in size and causes the dividing streamline to move upwards towards the cavity tips. By calculating the average height of this dividing streamline, this gives an effective change in gap height that accounts for the fact that the outer flow does essentially move through a slightly larger gap height than one located at the tips of the cavity walls.

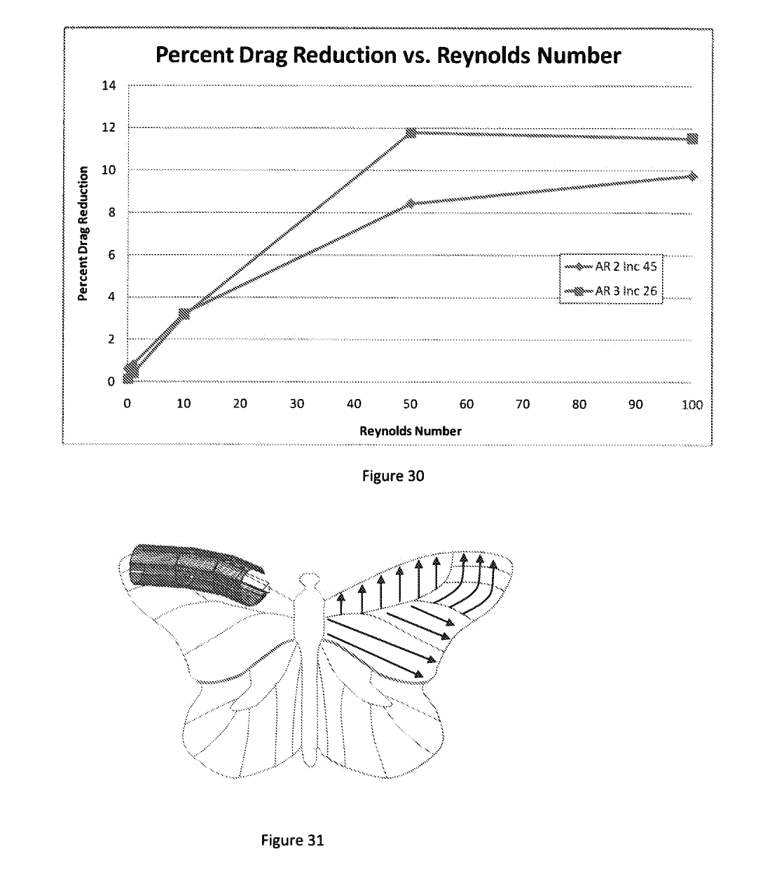

Comparing now the drag that would occur in a Couette flow consisting of this adjusted gap height, located at the average height of the dividing streamline, an interesting result occurs. As shown in FIG. 30, the net drag reduction at very low Re is almost entirely canceled out due to the fact that the dividing streamline is located fairly deep within the cavity (see Re=1 case in FIG. 28a). However, as the Re increases, the dividing streamline moves up towards the tips of the cavities, resulting in a net maximal drag reduction of about 12% for the AR=3 case.

It is contemplated that the Re range corresponding to maximal net drag reduction provides the fundamental biological reason for the sizing of butterfly scales. First, although the Monarch has not been specifically studied for this variation as of yet, recent work has shown that the scales on the Blue Pansy (Junonia orithya), an aggressive flyer, generally decrease in size from the wing base towards the edge. This reduction in scale size can be as much as 40%, and the reason for this occurrence was attributed to a maturation wave. However, there is no proven biological function for the microscopic scale-size distribution over the wings. From a fluid dynamic standpoint though, it is clear that during flapping forward flight the flow induced over a butterfly wing will be greatest towards the edge due the rotational tip speed of the wing. Thus, it is contemplated that the sizing of the scales can decrease towards the leading edge of the surface in order to keep the local Re of the flow over the scales in the proper range for maximal drag alteration at peak flying speeds.

Further, during both gliding and flapping flight, because the wing is modeled as a thin plate, separation of the flow occurs at the leading edge. For flapping flight, this can lead to the formation of a leading edge vortex, now well understood as an important mechanism for lift generation, as illustrated in FIG. 31. During gliding flight, a smaller sized laminar separation bubble which also increases lift can also form. Both these cases result in flow reversal on the front portion of the wing. Previously it was observed that the arrangement of the scales subsist of rows that form perpendicular to the veins on the wings (FIG. 26a-e). Based on this scale orientation, it can be surmised that in the regions of flow reversal the local flow actually passes over the scales parallel to the rows and this causes a forward axial force on the wing. Further, it is contemplated that this increased surface drag also harnesses energy from the leading edge vortex, and results in a decrease in vortex growth rate (reduced circulation) as well as an overall reduction in the induced drag (or reduced amount of energy left in the wake). All these effects—decreased surface drag over large portions of the wing due to the roller bearing effect, increased forward axial force in separated (reversed) flow regions, as well as a reduction in induced drag—combine to allow the butterfly to fly through the air with less flow resistance and reduces the overall energy requirement during flapping flight for the insect.

The preceding description is provided as an enabling teaching in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. The corresponding structures, materials, acts, and equivalents of all means or step plus function elements in the claims below are intended to include any structure, material, or acts for performing the functions in combination with other claimed elements as specifically claimed.

Accordingly, those who work in the art will recognize that many modifications and adaptations to the present invention are possible and can even be desirable in certain circumstances and are a part of the present invention. Other embodiments of the invention will be apparent to those skilled in the art from consideration of the specification and practice of the invention disclosed herein. Thus, the preceding description is provided as illustrative of the principles of the present invention and not in limitation thereof. It is intended that the specification and examples be considered as exemplary only, with a true scope and spirit of the invention being indicated by the following claims.

What is claimed is:

1. An aerodynamic or hydrodynamic wall surface configured to reduce frictional drag between the wall surface and a fluid flowing relative to the wall surface, comprising:
a plurality of roughness elements disposed on and extending therefrom the wall surface, wherein each roughness element has a front, upstream surface and an opposing rear, downstream surface, wherein the plurality of roughness elements are positioned substantially transverse to the flow of fluid across the wall surface, wherein the plurality of roughness elements are positioned to define at least one embedded cavity therebetween successive roughness elements, wherein the flow of fluid relative to the wall surface forms at least one cavity vortex rotating therein each embedded cavity, wherein at a predetermined fluid flow rate relative to the wall surface, at least a portion of the at least one cavity vortex rotates outside of the cavity, and wherein the at least one cavity vortex reduces friction between the fluid and the wall surface.

2. The wall surface of claim 1, wherein each cavity vortex contains a predetermined volume of fluid.

3. The wall surface of claim 2, wherein the plurality of roughness elements are configured so that the volume of fluid therein each cavity vortex is substantially constant as fluid flows relative to the wall surface.

4. The wall surface of claim 3, wherein the at least one cavity vortex rotating therein each embedded cavity forms a fluidized bearing surface.

5. The wall surface of claim 1, wherein at the predetermined fluid flow rate relative to the wall surface, at least a portion of the rotating cavity vortex has a vortex height greater than a depth of the respective cavity.

6. The wall surface of claim 1, wherein the plurality of roughness elements are positioned in successive ridges of roughness elements.

7. The wall surface of claim 6, wherein the at least embedded cavity is formed between the successive ridges of roughness elements.

8. The wall surface of claim 1, wherein at least a portion of at least one roughness element of the plurality of roughness elements is curved.

9. The wall surface of claim 1, wherein at least one roughness element of the plurality of roughness element extends therefrom the wall surface at an acute angle relative to the to the portion of the wall surface from which the at least one roughness element extends.

10. The wall surface of claim 9, wherein at least one roughness element of the plurality of roughness element extends therefrom the wall surface at an angle of about 45 degrees relative to the portion of the wall surface from which the at least one roughness element extends.

11. The wall surface of claim 1, wherein at least one roughness element of the plurality of roughness element extends substantially normal to the underlying wall surface.

12. The wall surface of claim 1, wherein the at least one embedded cavity has a ratio of length in the direction of fluid flow to depth of at least 1:1.

13. The wall surface of claim 12, wherein the ratio of length in the direction of fluid flow to depth is at least 2:1.

14. The wall surface of claim 1, wherein the front, upstream surface of each roughness element has a curved, convex cross-sectional shape relative to the flow of fluid over the wall surface.

15. The wall surface of claim 14, wherein the rear, downstream surface of each roughness element has a curved, concave cross-sectional shape relative to the flow of fluid.

16. An aerodynamic or hydrodynamic wall surface configured to reduce frictional drag between the wall surface and a fluid flowing relative to the wall surface, comprising:
a plurality of roughness elements disposed on and extending therefrom the wall surface, wherein the plurality of roughness elements are positioned relative to the flow of fluid across the wall surface such that a cavity is defined between each successive roughness element; and
means for restricting fluid from entering or leaving each cavity to alleviate the no-slip condition formed between the wall surface and the fluid flowing relative to the wall surface.

17. The wall surface of claim 16, wherein the means for restricting fluid from entering or leaving each cavity comprises configuring the roughness elements such that a rotating vortex is formed therein each cavity, wherein the rotating vortex restricts the flow of fluid flowing relative to the wall surface from entering each cavity.

18. The wall surface of claim 17, wherein at a predetermined fluid flow rate relative to the wall surface, at least a portion of the rotating vortex has a vortex height greater than a depth of the cavity in which the vortex is formed.

19. The wall surface of claim 18, wherein each cavity has a ratio of cavity length in the direction of fluid flow to depth of at least 1:1.

20. The wall surface of claim 19, wherein the ratio of length in the direction of fluid flow to depth is at least 2:1.

21. A method for reducing frictional drag between a wall surface and a fluid flowing relative to the wall surface, comprising:
providing a plurality of roughness elements disposed on and extending therefrom the wall surface, wherein the plurality of roughness elements are positioned relative to the flow of fluid across the wall surface such that a cavity is defined between each successive roughness element; and
forming a trapped rotational vortex in each cavity.

22. The method of claim 21, wherein at a predetermined flow rate of the fluid relative to the wall surface, a portion of the trapped rotational vortex extends out of the cavity.
